(19) United States
(12) Patent Application Publication
(10) Pub. No.: US 2003/0221769 A1
(43) Pub. Date: Dec. 4, 2003

(54) Transfer casting of holographic images

(76) Inventors: Wilhelm P. Kutsch, Middleton, NH (US); Stephen A. Orroth, Ipswich, MA (US); Jeffrey S. Gagnon, Candia, NH (US)

Correspondence Address: LISA M. SOLTIS, ILLINOIS TOOL WORKS INC., 3600 WEST LAKE AVENUE, GLENVIEW, IL, 60025, US

(21) Appl. No.: 10/153,964

(22) Filed: May 23, 2002

(51) Int. Cl. B44C 1/165

(52) U.S. Cl. 156/230

(57) ABSTRACT

A method and apparatus for transferring holographic images and diffraction patterns from a primary film surface, which contains the original holographic image or diffraction pattern, to a secondary film or substrate.

### TECHNICAL FIELD

This invention relates to the transfer of a holographic image or diffraction pattern from a primary film to a secondary surface.

### BACKGROUND

Holography has been widely used in a variety of decorative and security application to produce the appearance of three dimensional images on many substrates. Examples of the application of Holograms or diffraction patterns are the attachment of a hologram to credit cards, in order to authenticate their genuineness and increase the difficulty of counterfeiting, and anti counterfeiting devices on a number of other types of documents, such as stock certificates, travelers checks, identification cards, drivers licenses, passports and even currency. Diffraction patterns are commonly used in decorative applications such as gift-wrap, packaging, and other types of promotional application.

The predominant method of manufacturing such surface relief hologram is by recording an original hologram or dot matrix pattern, in a medium such as photoresist, or by laser ablation. It is also standard practice to replicate surface relief holograms by preparing a durable master in form of a nickel electroformed shim, as an embossing tool for thermally embossing the surface relief hologram into polymeric coatings, coextruded films such as coex BOPP, and pre-coated films such as PET, BOPP, and nylon. Additionally, precoated or extrusion coated paper can be embossed to replicate holographic or diffraction images. The embossing tool can also serve as a casting tool, where holographic images are cast directly onto a film and cured via UV radiation.

The holograms are generally manufactured in the form of a roll of material. In most cases the roll of film is then vacuum metallized with aluminum, via a conventional vacuum metallizing process, to give the hologram reflectivity, or vacuum coated with a transparent, high index of refraction coating such as zinc sulfide, to preserve the image during subsequent processing. Based on the final application of the hologram the images are either adhesive coated with a pressure sensitive adhesive, or heat activated adhesive as in the case of holographic or diffraction hot stamping foils. In either case, the hologram usually carries the holographic information in a surface relief pattern that is formed by either embossing into a film, or polymeric coating, or by casting a liquid resin onto a film.

The method employed in the prior art for casting holograms to surfaces, uses a holographic image embedded in either a cylinder or belt. The transfer of the images is directly from a belt or cylinder or from a drum, and therefore has limited application due to shim lines, or visible pattern overlap created in the casting process.

### SUMMARY OF THE INVENTION

A method of transferring a holographic image or a diffraction pattern embossed onto a primary film surface to a secondary film surface is disclosed. The method comprises applying a radiation curable composition to the secondary film surface, joining the primary surface and the secondary surface, curing the curable composition, and separating the primary and secondary surfaces. The curable composition may also be applied to the primary surface, for casting on opaque surfaces.

The primary film is preferentially a transparent biaxially oriented coextruded polypropylene film (coex BOPP). The primary film is not limited to transparent coex BOPP only. Films such as non-coextruded polypropylene, cast polypropylene, or other films with a low surface energy that are holographically embossable, could be employed. The secondary surfaces can be any transparent flexible film surface such as those comprising polyesters including for example polyethylene terephthalates (PET), polybutylene terephthalates (PBT) and the like; polyamides (nylons), polyethylenes; polycarbonates; polyvinyl chlorides; and polyimides.

The radiation curable composition may be a 1-5 micron thin filmultraviolet or electron beam curable coating (UV coating). The UV coatings employed are tailored to the individual secondary substrates so as to exhibit preferential adhesion to the secondary substrate and not to the primary surface film. The UV coatings comprise low viscosity monomers and oligomers, with a variety of functionalities to promote adhesion, wetting and cure speed. A photoinitiator may optionally be added to initiate the cross linking process.

The curable composition preferably comprises an acrylic monomer. The acrylic monomer comprises at least one (meth)acrylate group having the structure

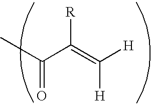

wherein R is hydrogen (i.e., an acrylate group) or methyl (i.e., a methacrylate group).

In one embodiment, the acrylic monomer is a monofunctional acrylic monomer having one (meth)acrylate group with the structure above. In another embodiment, the acrylic monomer is a difunctional acrylic monomer having two (meth)acrylate groups with the structure above. In another embodiment, the acrylic monomer is a trifunctional acrylic monomer having three (meth)acrylate groups with the structure above

Suitable monofunctional acrylic monomers include, for example, 2-phenoxyethyl (meth)acrylate, 3-phenoxypropyl (meth)acrylate, ethoxylated nonyl phenol(meth)acrylates having 2 to about 10 ethoxy groups, propoxylated nonyl phenol(meth)acrylates having 2 to about 10 propoxy groups, and the like. It will be understood that the prefix (meth)acryl-denotes either acryl- or methacryl-.

Suitable difunctional acrylic monomers include, for example, 1,4-butanediol di(meth)acrylate, 1,6-hexanediol di(meth)acrylate, 1,3-propylene glycol di(meth)acrylate, diethylene glycol di(meth)acrylate, propoxylated neopentyl glycol di(meth)acrylates having 2 to about 10 propoxy groups, ethoxylated neopentyl glycol di(meth)acrylates having 2 to about 10 ethoxy groups, and the like.

Suitable trifunctional acrylic monomers include, for example, glycerol tri(meth)acrylate, trimethylolpropane tri(meth)acrylate, pentaerythritol tri(meth)acrylate, ethoxylated trimethylolpropane tri(meth)acrylates having 2 to about 10 ethoxy groups, propoxylated trimethylolpropane tri(meth)acrylates having 2 to about 10 propoxy groups,

The curable composition may comprise an adhesion promoting monomer, which is generally a difunctional acrylic monomer, a trifunctional acrylic monomer, or a higher-order polyfunctional acrylic monomer (i.e., an acrylic monomer having at least four (meth)acrylate groups as defined above).

Additional acrylic monomers include, for example, trifunctional urethane (meth)acrylates, hexafunctional urethane (meth)acrylates, and the like.

It will be understood that mixtures comprising any of the above acrylic monomers may be employed.

In a preferred embodiment, the curable composition comprises a monofunctional monomer, a difunctional monomer, a trifunctional monomer, and an adhesion promoting monomer.

The curable composition may, optionally, further comprise a photoinitiator. Suitable photoinitiators include, for example, alpha-hydroxyketone type photoinitiators such as butyroin, benzoin, and acetoin.

The viscosity of a typical UV coating ranges between 80-120 cps (centipoises). Polypropylene films such as coextruded biaxially oriented polypropylene (coex BOPP) are the preferred as a transfer medium (primary film), because of the low surface energy, easy embossability, and the fact that most UV coatings do not adhere to BOPP, and therefore totally transfer to the secondary film without a residue or stick back. Typically, the surface tension of untreated BOPP is in the range of 29-31 dyne/cm, which places the surface energy into the low range just slightly above that of silicone polymers that are approximately in the range of 24-25 dynes/cm. The surface tension of UV inks and coatings can range between 30 and 45 dynes/cm, although 34-36 dynes/cm is typical. Historically a rule of thumb is used which states that good adhesion of UV coatings to a substrate requires that the surface energy level of the substrate is 10 dynes/cm higher than the surface tension of the coating. Based on the rule of thumb, the secondary surface should ideally have a minimum surface tension of 45 dynes/cm (preferably higher), to obtain good bonding between the UV coating and the secondary substrate. Hence, the poor adhesion of a UV coating to the BOPP. The secondary substrates are therefore preferably pretreated with a surface treatment such as a high surface energy polymeric coating, corona, flame or plasma treatment to promote adhesion of the UV coating. Pretreatments of the primary film surface, with a coating, a corona, flame or plasma treatment should be avoided.

A significant advantage in using coex BOPP as the primary film is found in the fact that once the image is transferred to the secondary film, the coex BOPP is separated from the secondary film, rewound into a roll form and ready for reuse. The primary film can be reused numerous times until the quality of the image thereon is degraded and commercially not acceptable. The primary film can be used in excess of twenty transfer passes without reduction in image quality.

The transfer process is not limited to transparent flexible films only. Substrates such as paper, paperboard, foil, fabric, leather, and opaque films can also be used as the secondary surface with a holographic image or diffraction patterns, in a slightly modified process. An advantage of a transfer casted holographic film over a conventionally embossed precoated film is that the holographic image is stable and resistant to higher heat during a laminating process, due to the fact that the UV polymer is highly cross linked and will not flow when heat is applied.

Another advantage is the fact that casted images have a substantially higher image quality and reflectivity when subsequently vacuum metallized. If flexible films such as polyethylene terephthalate (PET) are directly embossed, the heat and pressure of the embossing has the tendency to distort the film, reduce the clarity of the film, and to shrink the film. In the transfer casting method the secondary film is never subjected to such physical abuses.

Also, holographic images can be transfer casted onto substrates that are not embossable with current technology or directly embossable with an image quality that is commercially acceptable.

### BRIEF EXPLANATION OF THE DRAWINGS

FIG. 1 is a representation of an apparatus and method for transfer casting of a holographic image or diffraction pattern from a primary film to a secondary film; and

FIG. 2 is a representation of an apparatus and method for transfer casting of a holographic image or diffraction pattern from a primary film to an opaque substrate.

FIGS. 3A-3C depict a holographic device made by the method of FIG. 1.

FIGS. 4A-4C depict a holographic device made by the method of FIG. 2.

### DETAILED DESCRIPTION OF THE INVENTION

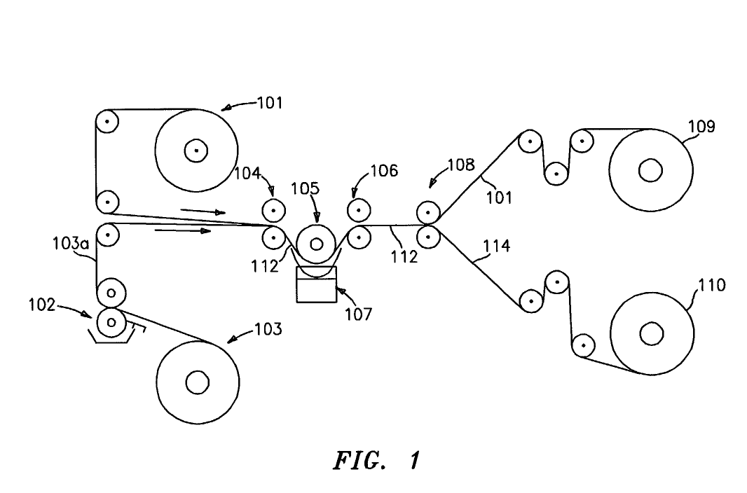

Referring to FIG. 1, a roll of primary film 101, such as coextruded biaxially oriented polypropylene (coex BOPP), is physically embossed with a holographic image or diffraction pattern, in a conventional offline embossing process. The primary film 101 is unwound and brought into contact with a secondary film 103 at a first nip station 104.

A roll of secondary film 103, such as a commercially available chemically pretreated PET with a high energy surface coating, is unwound, and a thin film (about 1-5 micron) of an ultraviolet (UV) or electron beam curable coating comprising for example a mono-functional monomer such as 2-phenoxyethyl acrylate, an adhesion promoting monomer such as alkoxylated trifunctional acrylate ester, a di-functional monomer such as propoxylated₂ neopentyl glycol diacrylate, a tri-functional monomer such as ethoxylated₆ trimethylolpropane triacrylate, a di-functional monomer such as 1,6-hexanediol diacrylate and a photoinitiator such as alpha-hydroxyketone blend is deposited thereon at 102 for example via a conventional direct gravure or offset gravure process. The UV coated secondary film 103, including an adhesion promoter such as alkoxylated trifunctional acrylate ester will aid in the adhesion of the cured UV coating to the secondary film 103. The UV coating is deposited evenly and without defects, such as bubbles or flow marks, in order to obtain a defect free casting of the holographic image or diffraction pattern. The mass percentages of the composition of the UV or electron beam curable composition for a chemically pretreated secondary film 103 is as shown for example in Table 1.

TABLE 1

| Class | Chemical Name | Mass | |
|---|---|---|---|
| Mono-Functional | 2-Phenoxyethyl Acrylate | | 1.38 kg |
| Monomer | | | |
| Adhesion Promoting | Alkoxylated Trifunctional Acrylate | | 1.38 kg |
| Monomer | Ester | | |
| Di-Finctional | Propoxylated₂ Neopentyl Glycol | | 0.98 kg |
| Monomer | Diacrylate | | |
| Tri-Functional | Ethoxylated₆ Trimethylolpropane | | 3.46 kg |
| Monomer | Triacrylate | | |
| Di-Functional | 1,6-Hexanediol Diacrylate | | 1.38 kg |
| Monomer | | | |
| Photoinitiator | Alpha-Hydroxyketone blend | | 1.42 kg |
| | | Total | 10.0 kg |

If non-pretreated PET or other substrates are employed as the secondary film 103, then a primer coat, corona treatment, flame treatment, or other forms of surface pretreatment, may be recommended to increase bond strength. For a non pretreated secondary film 103 a thin film of primer coat comprising for example a di-functional monomer such as 1,3-butylene glycol diacrylate, a tetra-functional diluents such as ethoxylated pentaerythritol tetraacrylate, a photoinitiator synergist such as reactive amine co-initiator, an aromatic urethane such as hexa-functional urethane acrylate and a photoinitiator such as alpha-hydroxyketone blend may first be deposited thereon via a conventional direct gravure or offset gravure process. The mass percentages of the composition of the primer coat for a non pretreated secondary film 103 is as shown for example in Table 2.

TABLE 2

| Class | Chemical Name | Mass | |
|---|---|---|---|
| Di-Functional Monomer | 1,3-Butylene Glycol | | 2.0 kg |
| | Diacrylate | | |
| Tetra-Functional Diluents | Ethoxylated Pentaerythritol | | 3.0 kg |
| | Tetraacrylate | | |
| Photoinitiator Synergists | Reactive Amine Co-initiator | | 0.7 kg |
| Aromatic Urethane | Hexa-functional Urethane | | 3.3 kg |
| | Acrylate | | |
| Photoinitiator | Alpha-Hydroxyketone blend | | 1.0 kg |
| | | Total | 10.0 kg |

The primary film 101 is unwound and brought into contact with the UV thin film coated side 103a of the secondary film 103, by passing the primary film 101 and the secondary film 103 through the low-pressure nip roller 104 creating thereby a composite film 112, e.g., the combination of the primary film 101 and the thin film coated secondary film 103a. The composite film 112, including the UV coating, is then subject to a high intensity UV light or electron beam source 107. The composite film 112 is held under tension, along a nip roller system 104, 106 and 108. A water-cooled support roller 105 is mounted opposite the high intensity UV light or electron beam source 107 to cool the composite film 112 during the curing step and to prevent film shrinkage. The UV coatings cure typically in a range of 0.01-0.10 seconds exposure, depending on the intensity of the UV light, thickness of the coating and UV chemistry employed.

The composite film 112 is then separated into the primary film 101 and a transfer casted film 114. The primary film 101 and the transfer casted film 114 are rewound onto separate rewind stands 109 and 110. The transfer casted film 114 is then ready for vacuum metallization, via a conventional vacuum metallization process, with, for example, an image enhancement layer such as Aluminum metal, or a “High Index of Refraction” coating, such as ZnS. This preserves the holographic image or diffraction pattern during further processing such as lamination, printing or coating. The primary film 101 can then be utilized again as the media for transfer casting to either additional substrates of the same kind or other substrates.

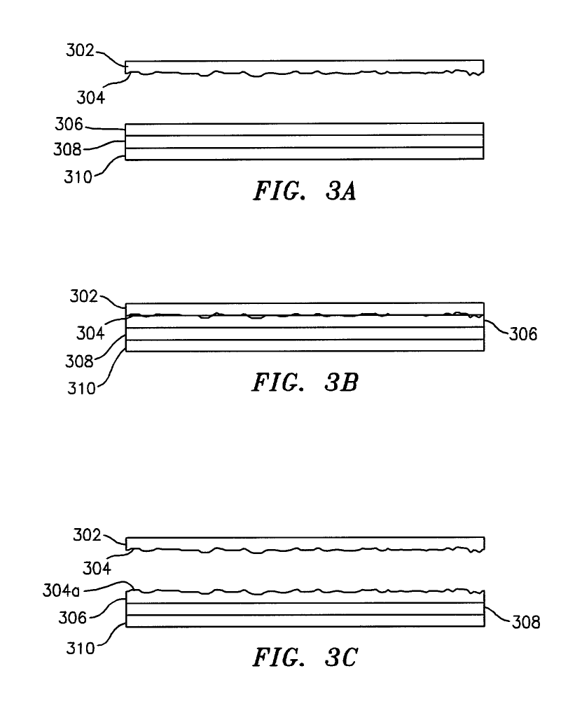

FIGS. 3A-3C depict a holographic device comprising a film substrate 310, a pretreatment layer 308 deposited on the film substrate 310, and a UV or electron beam curable layer 306 deposited on the pretreatment layer 308. The UV or electron beam curable layer 306 employed, includes an adhesion promoter either as an additive or as part of the UV chemistry. A low surface energy polypropylene primary film surface 302, having a surface relief hologram or diffraction pattern 304 embossed therein, is joined with the coated film substrate 310 (FIG. 3B). The curable layer 306 is crosslinked (or cured) with ultraviolet radiation, and the primary film surface 302 and the film substrate 310 are separated (FIG. 3C). The surface relief pattern 304 is now replicated in the crosslinked coating 306 as image 304a and the primary film surface 302 is now available for reuse.

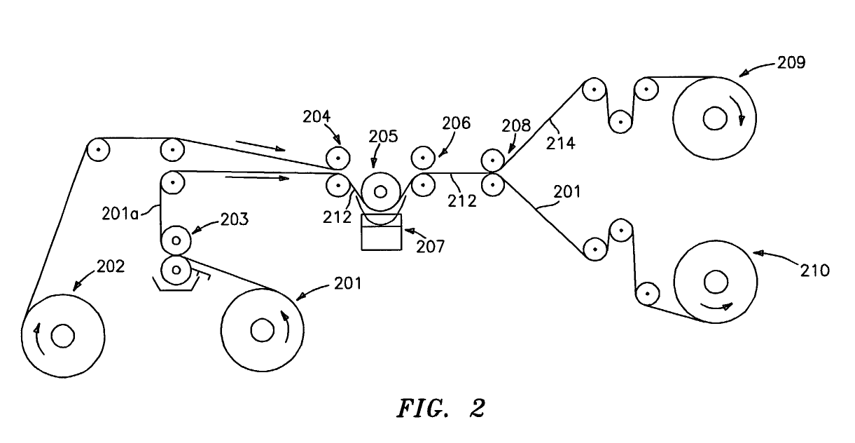

Referring to FIG. 2, a roll of primary film 201, such as coex BOPP, physically embossed with a holographic image or diffraction pattern, is unwound and coated at 203 with a thin film of an ultraviolet (UV) or electron beam curable coating 201a, that may comprise for example acrylic monomers including 2-phenoxy ethyl acrylate, 1,6-hexanediol diacrylate, and ethoxylated trimethylolpropane triacrylate via a conventional direct gravure 203 or offset gravure process.

A roll of an opaque substrate 202, such as paper, plastic, fabric or foil is unwound and brought into contact with the UV coated primary film 201a at a first nip station 204 creating thereby a composite film 212, e.g. the combination of the UV coated primary film 201 and the opaque substrate 202. The primary film-opaque substrate composite film 212 is then subject to a high intensity UV light or electron beam source 207 and kept under tension through second and third low pressure nip stations 206 and 208. Unlike the film-to-film transfer casting technique described in FIG. 1 above, where the secondary film 103 is positioned between the primary film 101 and the UV or electron beam source 107, in FIG. 2, the primary film 201 is positioned between the secondary film 202 and the UV or electron beam source 207. This allows the UV light or electron beam 207 to cure through the transparent primary film 201. A water cooled support roller 205 is mounted opposite the high intensity UV light or electron beam 207 to cool the primary film-opaque substrate composite film 212 during the curing step and to prevent shrinkage of the primary film 201.

The primary film-opaque substrate composite film 212 is then separated in line, and rewound onto separate rewind stands 209 and 210. The transfer casted opaque substrate 214 is then ready for vacuum metallization, via a conventional vacuum metallization process, with, for example, an image enhancement layer such as Aluminum or a “High Index of Refraction” (HRI) coating such as ZnS. This preserves the holographic image or diffraction pattern during further processing such as lamination, printing or coating. The primary film 201 can then be utilized again as a media for transfer casting to either additional substrates of the same kind or other substrates.

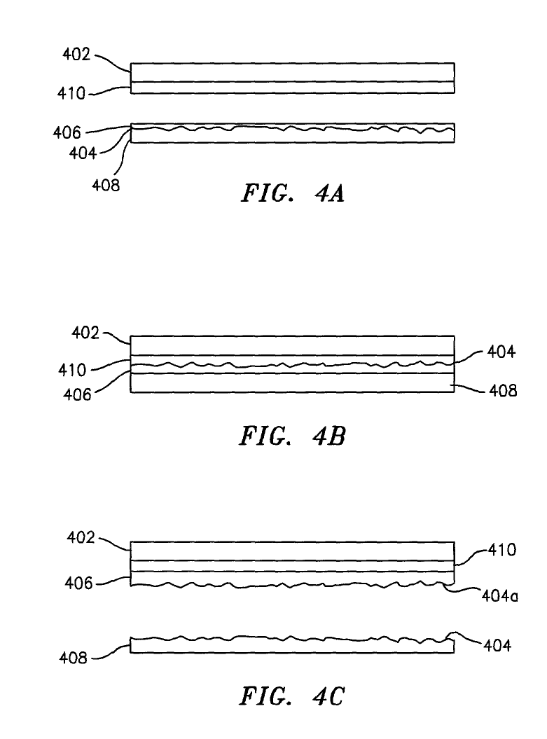

FIGS. 4A-4C depict a holographic device comprising a primary film surface 408 with a holographic image or diffraction pattern 404 embossed therein. Further, FIG. 4A shows a secondary surface 402 with a pretreatment layer 410 deposited on the secondary surface 402. A UV or electron beam curable coating 406 is deposited onto the low surface energy polypropylene primary film surface 408. The two substrates 402, 408 are joined, and the UV coating 406 is cured (FIG. 4B). The cured composite of FIG. 4B comprising the primary film 408, the UV coating 406 containing the holographic image or diffraction pattern 404, and the pretreated secondary substrate 402 are separated in FIG. 4C. The holographic image or diffraction pattern, as a surface relief pattern 404, is now replicated in the crosslinked, or cured, UV coating 406 as image 404a. The primary surface 408 is now available for reuse.

Thus, based upon the foregoing description, a method and apparatus for transferring a holographic image or a diffraction pattern embossed onto a primary film surface to a secondary film surface has been disclosed. The method comprises applying a curable composition to the secondary film surface, joining the primary surface and the secondary surface, curing the curable composition, and separating the primary and secondary surfaces. The curable composition may also be applied to the primary surface.

While the present invention has been described with reference to several embodiments thereof, those skilled in the art will recognize various changes that may be made without departing from the spirit and scope of the claimed invention. Accordingly, the invention is not limited to what is shown in the drawings and described in the specification, but only as indicated in the appended claims.

What is claimed is:

1. A method of transferring a holographic image or a diffraction pattern in a primary film surface to a secondary film surface, the method comprising:
applying a curable composition to the secondary film surface, the curable composition comprising an adhesion promoter causing the curable composition to exhibit preferential adhesion to the secondary film surface;
joining the primary film surface and the secondary film surface;
curing the curable composition; and
separating the primary and secondary film surfaces.

2. The method as set forth in claim 1 wherein the primary film comprises polypropylene.

3. The method as set forth in claim 2 wherein the polypropylene film comprises coextruded biaxially oriented polypropylene.

4. The method as set forth in claim 1 wherein the curable composition comprises a photoinitiator.

5. The method as set forth in claim 4 wherein the photoinitiator comprises an alpha-hydroxyketone.

6. The method as set forth in claim 1 wherein the curable composition comprises an acrylic monomer.

7. The method as set forth in claim 6 wherein the acrylic monomer is selected from the group consisting of 2-phenoxyethyl acrylate, 1,6-hexanediol diacrylate, ethoxylated₆ trimethylolpropane triacrylate, propoxylated₂ neopentyl glycol diacrylate.

8. The method as set forth in claim 1 wherein the adhesion promoter comprises an alkoxylated trifunctional acrylate ester.

9. The method as set forth in claim 1 wherein the secondary film is selected from the group consisting of polyesters, polyamides, polyethylenes, polycarbonates, polyvinyl chlorides, and polyimides.

10. The method as set forth in claim 1 wherein the secondary film is selected from the group consisting of paper, foil, fabric or opaque plastic film.

11. The method as set forth in claim 1 further comprising applying a primer coat to the secondary film surface.

12. The method as set forth in claim 11 wherein the ingredients of the primer coat are selected from the group consisting of 1,3-butylene glycol diacrylate, ethoxylated pentaerythritol tetraacrylate, reactive amine co-initiator, hexa-functional urethane acrylate and an alpha-hydroxyketone.

13. A holographic device made by the method as set forth in claim 1.

14. A holographic device made by the method as set forth in claim 11.

15. A holographic device comprising:
a film substrate;
a pretreatment film deposited on the film substrate;
a curable composition deposited on the pretreatment film, the curable composition comprising a holographic image or diffraction pattern transferred thereto by:
applying the curable composition to the pretreatment film, the curable composition comprising an adhesion promoter which causes the curable composition to exhibit preferential adhesion to the secondary surface;
joining the primary film surface having a holographic image or diffraction pattern embossed therein and the film substrate;
curing the curable composition; and
separating the primary film surface and the film substrate.

16. The holographic device as set forth in claim 15 wherein the curable composition comprises an acrylic monomer selected from the group consisting of 2-phenoxyethyl acrylate, 1,6-hexanediol diacrylate, ethoxylated₆ trimethylolpropane triacrylate, propoxylated₂ neopentyl glycol diacrylate.

17. The holographic device as set forth in claim 15 wherein the curable composition comprises a holographic image or diffraction pattern transferred thereto further by applying a primer coat to the secondary film surface.

18. The holographic device as set forth in claim 17 wherein the ingredients of the primer coat are selected from the group consisting of 1,3-butylene glycol diacrylate, ethoxylated pentaerythritol tetraacrylate, reactive amine co-initiator, hexa-functional urethane acrylate and an alpha-hydroxyketone.

19. The method as set forth in claim 1 wherein curing the curable composition comprises curing the curable composition with ultraviolet radiation or electron beam radiation.

20. The method as set forth in claim 1 wherein applying a curable composition to the secondary film surface comprises applying a thin film of curable composition to the secondary film surface.

21. The method as set forth in claim 21 wherein the thin film is 1 to 5 microns in thickness.
